(19) United States
(12) Patent Application Publication
(10) Pub. No.: US 2026/0092943 A1
(43) Pub. Date: Apr. 2, 2026

(54) Runway Indicator Device

(71) Applicant: Gordon Panika, Whale Cove (CA)

(72) Inventor: Gordon Panika, Whale Cove (CA)

(21) Appl. No.: 18/903,404

(22) Filed: Oct. 1, 2024

(51) Int. Cl. G01P 13/02

(52) U.S. Cl. CPC G01P 13/02

(57) ABSTRACT

An indicator device for indicating a direction of wind includes at least one mounting structure. The indicator device is adapted to be mounted to a pole arranged on a side of a runway for an airplane. The at least one mounting structure is adapted to facilitate a mounting of the indicator device to the pole. The indicator device also includes an indicator coupled to the at least one mounting structure and adapted to rotate around the pole. The indicator includes a light to indicate the direction of wind, and a drift plate coupled to the light to align the light in the direction of the wind. The drift plate causes a rotation of the light around the pole as the wind hits the drift plate.

### BACKGROUND OF THE INVENTION

The present disclosure relates, generally, to an indicator device adapted to be mounted a pole arranged at a side of a runway, and more particularly to an indicator device suitable to provide an indication of a wind direction to the pilots of the airplanes.

Winter snowfall and direction of blowing wind are important factors in the take-off and landing of the aircraft in cold areas. Snow drift makes it difficult for pilots to land an aircraft on a runway or take-off the aircraft from the runway as the drifting snow reduces the visibility and makes it hard to recognize the runway as well as direction of wind, which are critical to safe operation of the aircraft.

### SUMMARY OF THE INVENTION

According to an aspect of the disclosure, an indicator device for indicating a direction of wind and adapted to be mounted to a pole arranged on a side of a runway for an airplane is disclosed. The indicator device includes at least one mounting structure adapted to facilitate a mounting of the indicator device to the pole, and an indicator coupled to the at least one mounting structure and adapted to rotate around the pole. The indicator includes a light to indicate the direction of wind, and a drift plate coupled to the light to align the light in the direction of the wind. The drift plate causes a rotation of the light around the pole as the wind hits the drift plate.

In some additional, alternative, or selectively cumulative embodiments, the mounting structure includes a pair of protrusions adapted to be securely mounted to pole and arranged opposite to each other, and a pair of rings rotatably mounted to the pair of protrusions.

In some additional, alternative, or selectively cumulative embodiments, each ring is a semicircular ring having an outer surface and an inner surface defining a groove extending from the inner surface towards the outer surface to receive one of the pair of protrusions.

In some additional, alternative, or selectively cumulative embodiments, the indicator device further includes a pair of arms extending in a vertical direction and coupling the indicator to the at least one mounting structure.

In some additional, alternative, or selectively cumulative embodiments, the indicator device further includes a base attached to the pair of arms and adapted to be arranged proximate to a ground surface. The indicator is attached to the base.

In some additional, alternative, or selectively cumulative embodiments, the base includes two half portions defining an opening. The base is adapted be arranged around the pole such that pole extends through the opening.

In some additional, alternative, or selectively cumulative embodiments, the drift plate is attached to the base and extends at an inclination relative to the base.

In some additional, alternative, or selectively cumulative embodiments, the light is embedded inside the drift plate.

In some additional, alternative, or selectively cumulative embodiments, the pair of arms extends vertically upwardly and the drift plate is attached to one of the pair of arms.

In some additional, alternative, or selectively cumulative embodiments, the light is attached to and supported on the pair of arms and is arranged at an inclination relative to a horizontal direction.

In some additional, alternative, or selectively cumulative embodiments, the light includes an illuminated arrow to indicate the direction of the wind.

### BRIEF DESCRIPTION OF FIGURES

FIG. 1 illustrates a front perspective view of an indicator device mounted to a pole, in accordance with an embodiment of the disclosure;

FIG. 2 illustrates sectional view of the pole and a mounting structure of the indicator device of FIG. 1 attached to the pole, in accordance with an embodiment of the disclosure;

FIG. 3 illustrates a front perspective view of a ring of the mounting structure of FIG. 2, in accordance with an embodiment of the disclosure;

FIG. 4 illustrates a top view of the indicator device of FIG. 1, in accordance with an embodiment of the disclosure; and

FIG. 5 illustrates a front perspective view of an indicator device attached to a pole, in an accordance with an embodiment of the disclosure.

### DETAILED DESCRIPTION

Example embodiments are described below with reference to the accompanying drawings. Unless otherwise expressly stated in the drawings, the sizes, positions, etc., of components, features, elements, etc., as well as any distances therebetween, are not necessarily to scale, and may be disproportionate and/or exaggerated for clarity.

The terminology used herein is for the purpose of describing particular example embodiments only and is not intended to be limiting. As used herein, the singular forms “a,” “an” and “the” are intended to include the plural forms as well, unless the context clearly indicates otherwise. It should be recognized that the terms “comprise,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof. Unless otherwise specified, a range of values, when recited, includes both the upper and lower limits of the range, as well as any sub-ranges therebetween. Unless indicated otherwise, terms such as “first,” “second,” etc., are only used to distinguish one element from another. For example, one element could be termed a “first element” and similarly, another element could be termed a “second element,” or vice versa. The section headings used herein are for organizational purposes only and are not to be construed as limiting the subject matter described.

Unless indicated otherwise, the terms “about,” “thereabout,” “substantially,” etc. mean that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art.

Spatially relative terms, such as “right,” left,” “below,” “beneath,” “lower,” “above,” and “upper,” and the like, may be used herein for ease of description to describe one element's or feature's relationship to another element or feature, as illustrated in the drawings. It should be recognized that the spatially relative terms are intended to encompass different orientations in addition to the orientation depicted in the figures. For example, if an object in the figures is turned over, elements described as “below” or “beneath” other elements or features would then be oriented “above” the other elements or features. Thus, the term “below” can, for example, encompass both an orientation of above and below. An object may be otherwise oriented (e.g., rotated 90 degrees or at other orientations) and the spatially relative descriptors used herein may be interpreted accordingly.

Unless clearly indicated otherwise, all connections and all operative connections may be direct or indirect. Similarly, unless clearly indicated otherwise, all connections and all operative connections may be rigid or non-rigid.

Like numbers refer to like elements throughout. Thus, the same or similar numbers may be described with reference to other drawings even if they are neither mentioned nor described in the corresponding drawing. Also, even elements that are not denoted by reference numbers may be described with reference to other drawings.

Many different forms and embodiments are possible without deviating from the spirit and teachings of this disclosure and so this disclosure should not be construed as limited to the example embodiments set forth herein. Rather, these example embodiments are provided so that this disclosure will be thorough and complete, and will convey the scope of the disclosure to those skilled in the art.

Reference in this specification to “one embodiment” or “an embodiment” means that a particular feature, structure, or characteristic described in connection with the embodiment is included in at least one embodiment of the present disclosure. The appearance of the phrase “in one embodiment” in various places in the specification are not necessarily all referring to the same embodiment, nor are separate or alternative embodiments mutually exclusive of other embodiments.

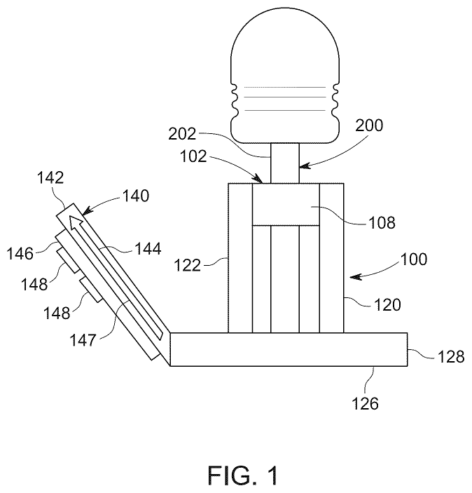

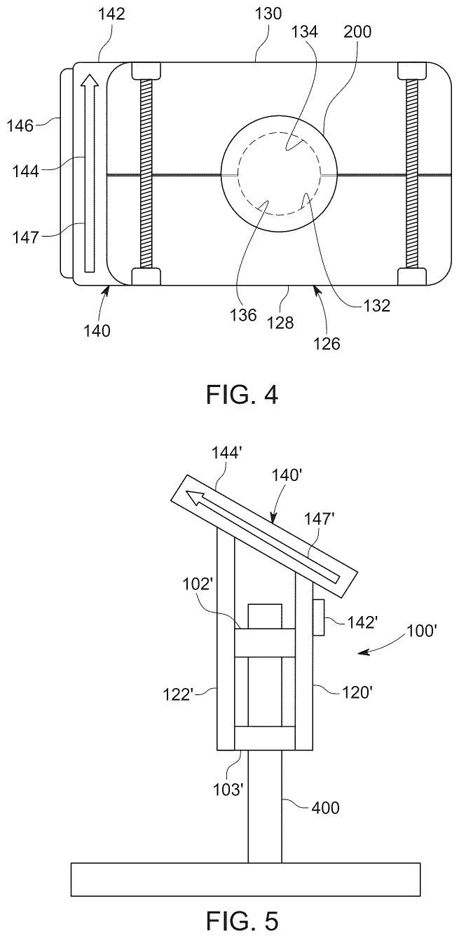

Referring to FIGS. 1 and 4, an indicator device 100 (hereinafter simply referred to as device 100) adapted to be mounted to a pole 200 arranged at a side of a runway for airplanes is shown. The device 100 is adapted to be removably mounted to the pole 200 and includes a mounting structure 102 having a pair of protrusions 104, 106 fastened to the poles 200 using screws and protruding outwardly from an outer surface 202 of the pole 200. The protrusions 104, 106 are arranged on opposite sides of the poles 202.

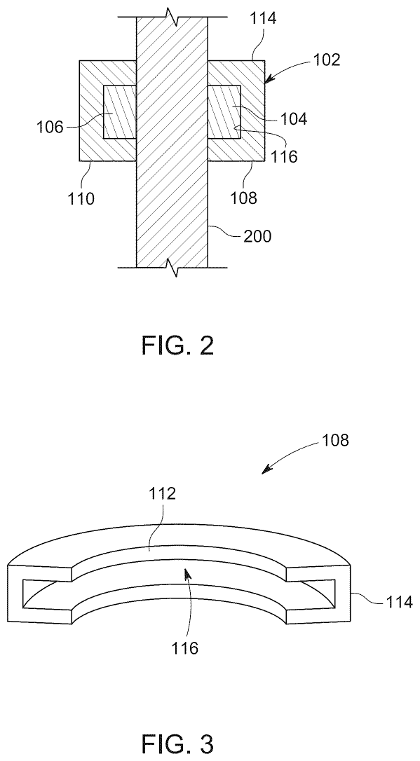

Further, as shown in FIG. 2, the mounting structure 102 includes a pair of semicircular rings 108, 110 attached to the pair of protrusions. It may be appreciated that the rings 108, 110 are identical to each other, and therefore, for sake of clarity and brevity, a structure and assembly only one ring 108 is described in detail. As shown in FIG. 3, the ring 108 has an outer surface 112 and an inner surface 114 defining a groove 116 extending from the inner surface 114 towards the outer surface 112. The shape of the groove 116 is complementary to the shape of the protrusion 104 to enable an insertion of the protrusion 104 inside the groove 116 to enable a mounting of the ring to the protrusion 104. It may be noted that that an inner diameter of the ring 108 is substantially equal to an outer diameter of the pole 200 and a depth of the groove 116 is substantially equal to a width of the protrusion 104. In the assembly of the ring 108 with the protrusions 104, as shown in FIG. 2, the protrusion 104 extends inside the groove 116 of the ring 108 such that the inner surface 114 of the ring 108 is arranged contacting the outer surface 202 of the pole 200. In some embodiments, the rings 108, 110 may be also be engaged with each other using suitable fasteners. Also, the rings 108, 110 are arranged to rotate about a central axis of the pole 200 relative to the protrusions 104, 106.

Additionally, referring back to FIG. 1, the device 100 includes a pair of arms 120, 122 connected/engaged/coupled/attached/secured to the mounting structure 102 and extending vertically downwardly from diametrically opposite sides of the mounting structure 102 i.e., rings 108, 110. Further, the device 100 includes a base/platform 126 that may be arranged on a ground surface or above the ground surface. As shown, the arms 120, 122 are also attached to the base 126. As shown in FIG. 4, the base 126 includes two half portions 128, 130 having semicircular cut-outs 132, 134 to define an opening 136 through which the pole 200 extends. Also, the two half portions 128, 130 may be removably connected to each other via fasteners. A diameter of each of the cut-outs 128, 130 may be substantially equal to a diameter of the pole 200.

Moreover, referring to FIG. 1 and FIG. 4, the device 100 includes an indicator 140 to indicate a direction of wind and engaged to the base 126. As shown, the indicator 140 includes a first plate 142 that acts a drift plate 142 and extending vertically upwardly from an end of the base 126 and arranged at an inclination from the base 128. In an embodiment, an angle of inclination of the first plate 142 relative to the base i.e., ground surface is between 40 degrees and 75 degrees. Preferably, the angle of inclination is around 60 degrees. Also, the indicator 140 includes a light 144 arranged inside the first plate 142 to indicate a direction of wind. In some embodiments, the light 142 includes an illuminated arrow 147, as shown in FIGS. 1 and 4, with the tip of the arrow pointing the direction of the wind.

Further, the indicator 140 may include a second plate 146 coupled to the first plate 146 and adapted to be arranged at a first position and a second position. To facilitate the coupling of the first plate 142 and the second plate 146, the first plate 142 includes a pair of holes and the second plate 146 includes a pair of grooves aligned with the pair of holes. A pair of fasteners 148 extend through the aligned holes and grooves to secure the second plate 146 with the first plate 142. In the assembly, the second plate 146 extends substantially parallel to the first plate 146. In the first position, an upper end of the second plate 146 is arranged inwardly of an upper end of the first plate 142, while in the second position an upper end of the second plate 146 is arranged outwardly of the first plate 142. The second plate 146 helps in stabilizing the device 100 and directs the wind. The inclination of the first plate 142 and the second plate 146 helps in restricting the drifting of the snow on runway from sides of the runway.

Referring to FIG. 5, a runway indicator device 100′ (hereinafter simply referred to as device 100′) according to an embodiment is shown. The device 100′ is mounted to a pole 400 and is arranged at a side of a runway for airplanes, and includes a pair of mounting structures 102′, 103′ arrayed along a height of the pole 400. The mounting structures 102′, 103; are identical to the mounting structure 102 of the indicator device 100. Additionally, the device 100′ includes a pair of arms 120′, 122′ connected/engaged/coupled/attached/secured to the both the mounting structures 102′, 103′ and extending vertically upwardly from opposite ends of the mounting structures 102′, 103′. In the illustrated embodiment, one of the arms, for example, a first arm 120′, is shorter than other of the arms, for example, a second arm 122′.

Further, the device 100′ includes an indicator 140′ arranged supported on the pair of arms 120′ 122′. As the lengths of the arms 120′, 122′ are different, the indicator 140′ is arranged at an inclination to the ground surface. The indicator 140′ is arranged to indicate a direction of wind. In an embodiment, an angle of inclination of the indicator 140′ relative to the ground surface is between 40 degrees and 75 degrees. Preferably, the angle of inclination is around 60 degrees. Also, the indicator 140′ includes a light 144′ to indicate a direction of wind. In some embodiments, the light 144′ includes a shape of an arrow with the tip of the arrow arranged proximate to the second arm 122′ and a base of the arrow arranged proximate to the first arm 120′. The direction of the arrow points to the direction of the wind. Moreover, the device 100′ includes a drift box or plate 142′ attached to one of the arms, for example, the first arm 120′. The wind hits the drift plate 142′ to rotate the device 100′ around a central axis of the pole 400 to align the illuminated arrow 147′ in the direction of wind.

A working of the indicator device 100, 100′ is now described. As wind blows, the wind hits the drift plate 142, 142′, causing the rotation of the light 144, 144′ around a central axis of the pole 200, 400 as the rings 108, 110 are rotatably attached to the protrusions 104, 106 engaged with the pole 200, 400. Accordingly, the light 144, 144′ aligns with the direction of the wind such that the illuminated arrow 147, 147′ pointing the direction of the wind which can be easily seen by the pilots even when there is snow.

It should be understood that the foregoing description is only illustrative of the aspects of the disclosed embodiments. Various alternatives and modifications can be devised by those skilled in the art without departing from the aspects of the disclosed embodiments.

1. An indicator device for indicating a direction of wind and adapted to be mounted to a pole arranged on a side of a runway for an airplane, the indicator device comprising:
at least one mounting structure adapted to facilitate a mounting of the indicator device to the pole; and
an indicator coupled to the at least one mounting structure and adapted to rotate around the pole, the indicator includes a light to indicate the direction of wind, and
a drift plate coupled to the light to align the light in the direction of the wind, wherein the drift plate causes a rotation of the light around the pole as the wind hits the drift plate.

2. The indicator device of claim 1, wherein the mounting structure includes a pair of protrusions adapted to be securely mounted to pole and arranged opposite to each other, and a pair of rings rotatably mounted to the pair of protrusions.

3. The indicator device of claim 2, wherein each ring is a semicircular ring having an outer surface and an inner surface defining a groove extending from the inner surface towards the outer surface to receive one of the pair of protrusions.

4. The indicator device of claim 1 further comprises a pair of arms extending in a vertical direction and coupling the indicator to the at least one mounting structure.

5. The indicator device of claim 4 further comprises a base attached to the pair of arms and adapted to be arranged proximate to a ground surface, wherein the indicator is attached to the base.

6. The indicator device of claim 5, wherein the base includes two half portions defining an opening, wherein the base is adapted be arranged around the pole such that pole extends through the opening.

7. The indicator device of claim 5, wherein the drift plate is attached to the base and extends at an inclination relative to the base.

8. The indicator device of claim 7, wherein the light is embedded inside the drift plate.

9. The indicator device of claim 4, wherein the pair of arms extends vertically upwardly and the drift plate is attached to one of the pair of arms.

10. The indicator device of claim 9, wherein the light is attached to and supported on the pair of arms and is arranged at an inclination relative to a horizontal direction.

11. The indicator device of claim 1, wherein the light includes an illuminated arrow to indicate the direction of the wind.
